(19) United States
(12) Patent Application Publication
(10) Pub. No.: US 2006/0091244 A1
(43) Pub. Date: May 4, 2006

(54) Small-size automatic water spray device

(76) Inventor: Yixin Guo, Ronkonkoma, NY (US)

Correspondence Address: Yixin Guo, 256 Holbrook Avenue, Ronkonkoma, NY, 11779, US

(21) Appl. No.: 10/979,721

(22) Filed: Nov. 3, 2004

(51) Int. Cl. F23D 11/32

(52) U.S. Cl. 239/691

(57) ABSTRACT

It is a small-size automatic water spray device. The characteristic is: it comprises hose, timer, control circuit, electromagnetic valve and spray head. The hose inlet is connected to the tap water and its outlet is connected to the spray head so as to form into the water supply channel where the electromagnetic valve is installed. The output signal of the timer is connected to the input port of the control circuit and the output port of the control circuit is connected to the control end of the electromagnetic valve. This is a practicable and new type system in which the tap water is used as the source of water and the water supply channel and spray head are set up and the electromagnetic valve is installed in the water supply channel to spray water automatically on the potted flowers and grass and plants in the households, offices, public places and other indoor locations at a required time by opening the electromagnetic valve through the control circuit preset by the timer, thus to reduce the time of manually handling the potted flowers and grass and plants and increase the level of automated service for the potted flowers and grass and plants in the households, offices, public places and other indoor locations.

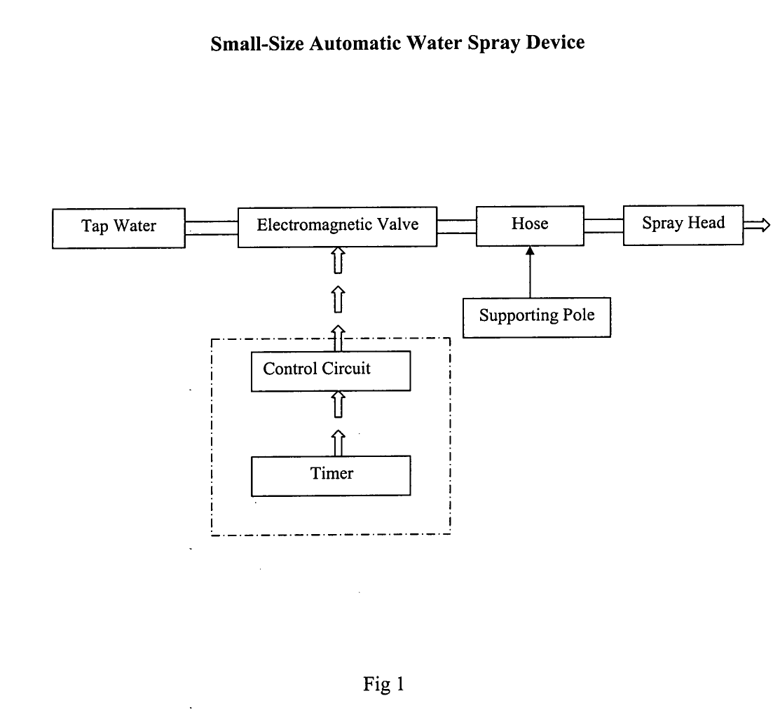

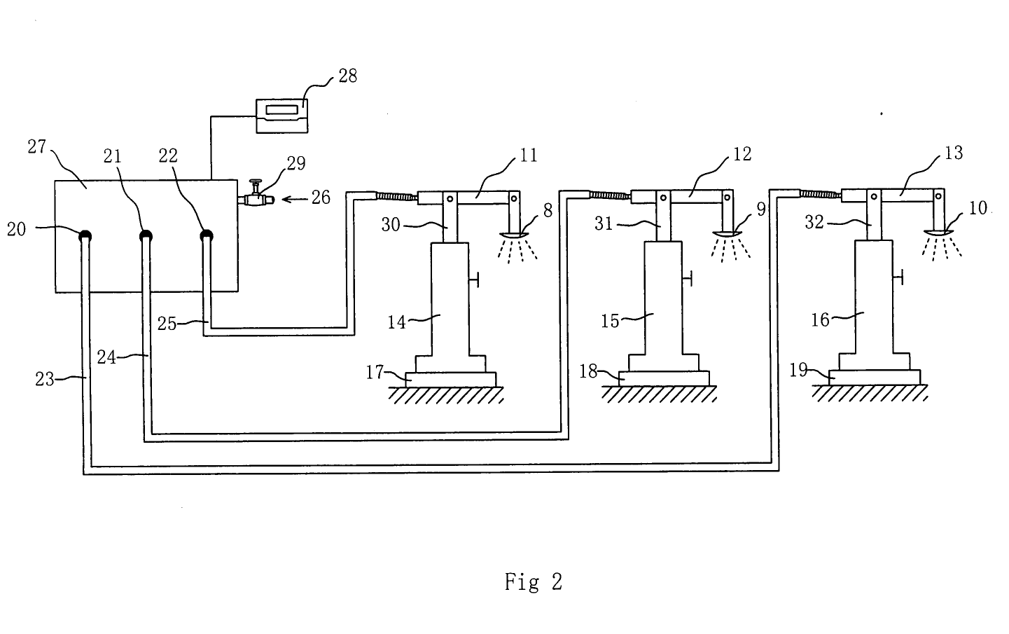

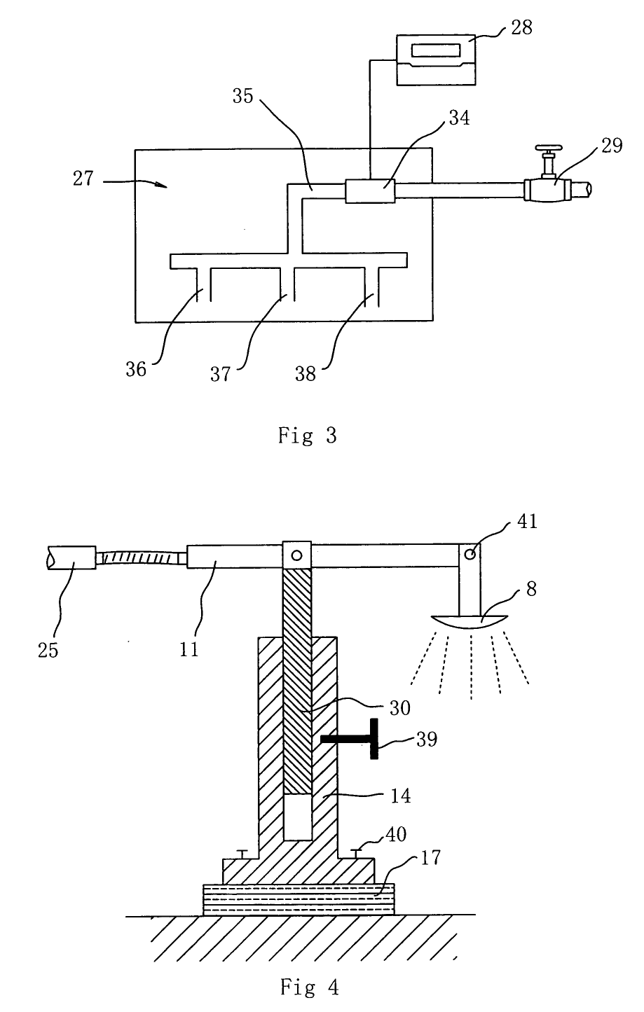

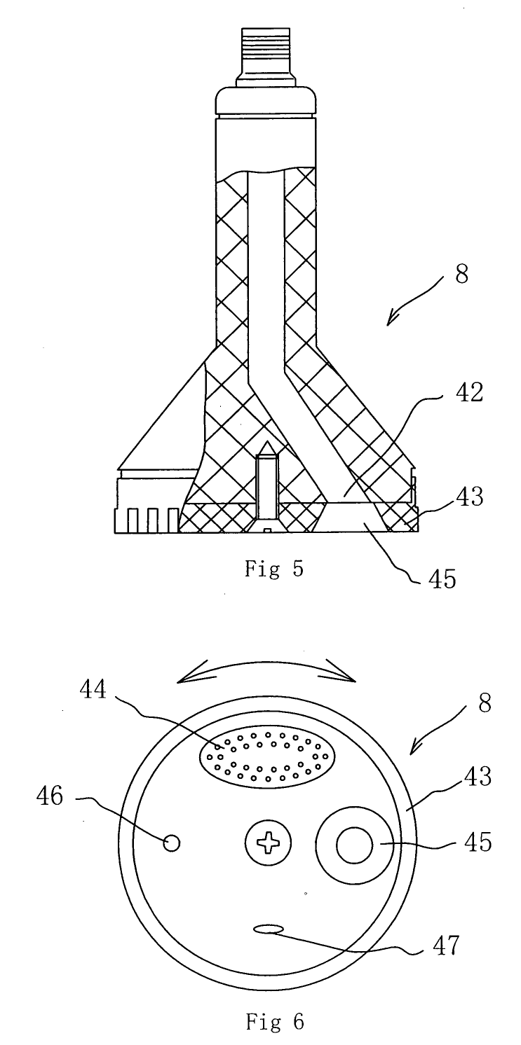

### FIELD OF THE INVENTION

This practicable and new type system relates to an electronic automatic water spray device and more particularly to a device that sprays water automatically on the potted flowers and grass or other plants in the households, offices, public places and other indoor locations. This device uses the water storage device as the source of water to spray water automatically at a required time by opening the electromagnetic valve preset by the timer.

### BACKGROUND OF THE INVENTION

With the improvement of the living standard, it has become a style for the people to grow flowers and plant grass to cultivate morality and preserve health. However, the indoor potted flowers and grass or other plants need to be watered regularly and carefully taken care of due to their different growth features. This is a kind of enjoyment anyway for those people who do not work and enjoy their leisure time at home. But for those people who work, they often forget to water the flowers, grass and plants which would be dry and dying due to their busy work as well as going out on vacation and sightseeing, or due to one-time over watering which causes the death of flowers, grass and plants because of the root rot. In addition, there is often the lack of watering management for the flowers and grass in the offices and public places.

On the other hand, the potted flowers and grass and plants in the households, offices, public places and other indoor locations are mostly watered manually and there has been no any special small-size automatic water spray device that can be seen in the market. Therefore, how to change the manual watering into the automated one to meet the need of the people who love to grow flowers and plant grass is the issue that this practicable and new type system needs to solve.

### SUMMARY OF THE INVENTION

This practicable and new type system provides a small-size automatic water spray device that sprays water automatically on the potted flowers and grass or other plants in the households, offices, public places and other indoor locations, the objective of which is to reduce the management time on indoor potted flowers and grass and plants and realize the automated watering so as to increase the level of automated service for the potted flowers and grass and plants in the households, offices, public places and other indoor locations.

In order to accomplish the above objective, the technical plan adopted by this practicable and new type system is: a small-size automatic water spray device that comprises hose, timer, control circuit, electromagnetic valve and spray head. The hose inlet is connected to the tap water and its outlet is connected to the spray head so as to form into the water supply channel where the electromagnetic valve is installed. The output signal of the timer is connected to the input port of the control circuit and the output port of the control circuit is connected to the control end of the electromagnetic valve.

The following is the explanation of the relevant contents and changes in the above-mentioned technical plan:
1. In the above plan, the timer can be mechanical type or electronic type structure controlled by the program.
2. There could be the following changes regarding the structure design of the said water supply channel:
   a) The water supply channel is composed of the connections between the general route and two branch routes at least. The spray head is installed at the end of each branch route and the electromagnetic valve is installed on the general route or on each branch route.
   b) The water supply channel forms into the tree-branch-shape channel by the connections of the general route, first-class branch route and second-class branch route. The spray head is installed at the end of the second-class branch route. The electromagnetic valve is installed on general route or on first-class branch route or on second-class branch route.
   c) Under the second condition said above, third-class branch route and fourth-class branch route can be also set up on some of the second-class branch routes, which will be decided according to the actual needs.
3. In the above plan, in order to adjust the water spray type according to the needs, such as general water flow, thick water flow, thin water flow and thin sprinkle so as to meet the water spray needs. The adjustment panel of water spray type is installed on the spray nozzle of said spray head. The spray holes of different water spray types are distributed at a distance around the adjustment panel circumference. The spray nozzle corresponds to the position of spray holes circumference. The spray nozzle, when turning the adjustment panel, corresponds respectively to the spray holes of different water spray types. The shape of the spray holes includes sprinkle hole, bell-bottomed hole, round hole and flat hole.
4. In the above plan, the following technical steps can be adopted in order to adjust the outer corner and height of the spray head to meet the position and direction of the water spray:
   a) The adoption of bending adjustment structure in which the said spray head is connected to the water supply channel through a section of soft tube covered with sleeve which can be bent and positioned so as to constitute the outer corner of spray head and the structure of universal height adjustment.
   b) The adoption of supporting adjustment structure in which the supporting stand is installed at the place of said spray head. The supporting stand comprises base stand, supporting pole and spray head pole. The supporting pole is inserted into the base stand and has a device to adjust the height and the spray head pole is installed on the supporting pole and the spray head can be turned and positioned on the spray head pole so as to constitute the adjustment structure of the outer corner and height of the spray head.
5. In the above plan, the control circuit and electromagnetic valve can both be disposed in a box on which there is a distribution channel in which the valve of the electromagnetic valve is installed. The timer should be installed solely in the indoor location where is convenient for adjustment.

The working principle of this practicable and new type system is: the tap water is used as the source of water and the water supply channel and spray head are set up and the electromagnetic valve is installed in the water supply channel to spray water automatically on the potted flowers and grass and plants in the households, offices, public places and other indoor locations at a required time by opening the electromagnetic valve through the control circuit preset by the timer (the opening time and duration is controlled by tinier), thus to reduce the time of manually handling the potted flowers and grass and plants and increase the level of automated service for the potted flowers and grass and plants in the households, offices, public places and other indoor locations.

Due to the adoption of the above technical plan, this practicable and new type system has the following advantages compared with the existing technology:
1. This practicable and new type system has a very simple structure which is reliable and replaces the manual watering, and also reduces the time of manually handling the potted flowers and grass and plants and increases the level of automated service for the potted flowers and grass and plants in the households, offices, public places and other indoor locations.
2. The installation and use are both convenient since this practicable and new type system is specially designed for use in the households, offices, public places and other indoor locations.
3. Since the tap water is used as the direct source of water in this practicable and new type system, it is very convenient for people to get water in the households, offices, public places and other indoor locations.
4. Since this practicable and new type system is specially designed for use in the households, offices, public places and other indoor locations, it is more applicable for use in the households, offices, public places and other indoor locations compared with outdoor large-size electronic automatic water spray system.

### BRIEF DESCRIPTION OF THE DRAWINGS

DRAWING 1 is the principle diagram of this practicable and new type system.

DRAWING 2 is the block diagram of this practicable and new type system with application examples.

DRAWING 3 is the block diagram of the interior box of this practicable and new type system with application examples.

DRAWING 4 is the supporting structure diagram of the spray head of this practicable and new type system with application examples.

DRAWING 5 is the block diagram of the spray head with different spray holes of this practicable and new type system.

DRAWING 6 is the upward view of DRAWING 5.

DRAWING 7 is the block diagram of the bend adjustment of the spray head of this practicable and new type system.

### DETAIL DESCRIPTION

In the above drawings, 8 to 10: spray head. 11 to 13: spray head pole. 14 to 16: base stand. 17 to 19: foundation bed. 20 to 22: opening of water outlet. 23 to 25: hose. 26: source of tap water. 27: box. 28: timer and control circuit. 29: tap water valve. 30 to 32: supporting pole. 34: electromagnetic valve. 35: general route. 36 to 38: first-class branch route. 39: bolt. 40: bolt. 41: bolt. 42: spray nozzle. 43: adjustment panel. 44: sprinkle hole. 45: bell-bottomed hole. 46: round hole. 47: flat hole. 48: soft tube. 49: sleeve.

The following is the further description of this practicable and new type system in conjunction with the accompanying drawings and the application examples:

Application Examples: referring to DRAWING 1, a small-size automatic water spray device which comprises source of tap water, hose, timer, control circuit, electromagnetic valve, spray head and supporting stand. The tap water is used as the source of water and the water supply channel and spray head are set up and the electromagnetic valve is installed in the water supply channel to spray water automatically on the potted flowers and grass and plants in the households, offices, public places and other indoor locations at a required time by opening the electromagnetic valve through the control circuit preset by the timer.

Referring to DRAWING 2, the electromagnetic valve is integrated with the distribution channel in the box 27. The openings of water outlet 20, 21 and 22 are connected to the hoses 23, 24 and 25. The hoses 23, 24 and 25 are connected to the spray head poles 11, 12 and 13. The spray head poles 11, 12 and 13 are fixed on the supporting poles 30, 31 and 32. The spray head poles 11, 12 and 13 are connected to the spray heads 8, 9 and 10. The spray heads 8, 9 and 10 at the front end of the spray head poles 11, 12 and 13 can be turned around at different angles. The structure to adjust the water spray type is adopted for the spray heads 8, 9 and 10. For example, the spray head carries the adjustment panel, on which there are respectively the sprinkle hole, bell-bottomed hole, round hole and flat hole which can spray the general water flow, thick water flow, thin water flow and thin sprinkle so as to meet the water spray needs. The supporting poles 30, 31 and 32 are located on the base stands 14, 15 and 16 and can be pulled up and down so as to adjust the height in order to fit the flowerpot position. The base stands 14, 15 and 16 are fixed on the foundation bed 17, 18 and 19 but the base stands 14, 15 and 16 are respectively separated from the foundation bed 17, 18 and 19 so that the base stands can be directly put into the flowerpot soil. The electromagnetic valve is installed in the water supply channel. The timer and the output signal of the timer in the control circuit 28 are connected to the input port of the control circuit and the output port of the control circuit is connected to the control end of the electromagnetic valve. The timer and the control circuit 28 control only one electromagnetic valve. The electromagnetic valve 34 is installed inside the box 27. The tap water valve 29 is used to switch on and off the source of tap water 26.

Referring to DRAWING 3, it is the block diagram of the interior box. The box 27 is composed of electromagnetic valve 34 and distribution channel which is composed of the connections between the general route 35 and three first-class branch routes 36, 37 and 38. Each first-class branch route is connected to the spray head through the hose. The electromagnetic valve 34 is installed on the general route 35. The electromagnetic valve 34 is controlled by the timer and control circuit 28.

Referring to DRAWING 4, it is the supporting structure diagram of the spray head 8. The supporting structure is composed of base stand 14, supporting pole 30 and spray head pole 11. The supporting pole 30 is inserted into the base stand 14 which can be pulled up and down to adjust the height and then is fixed by the bolt 39. The spray head pole 11 is connected to the supporting pole 30. The spray head 8 is turned and positioned on the spray head pole 11 by the bolt 41 to constitute the adjustment structure of the outer corner and height of the spray head. The hose 25 is connected to the spray head pole 11 and there is a channel in the spray head pole 11.

Referring to DRAWING 5 and 6, it is the block diagram of the spray head with different spray holes. The adjustment panel 43 of water spray type is installed in front of the spray nozzle 42 of the spray head 8. Four spray holes of different water spray types are distributed at a distance around the circumference of this adjustment panel 43. The spray nozzle 42 corresponds to the position of spray holes circumference. The spray nozzle 42, when turning the adjustment panel 43, corresponds respectively to four spray holes of different water spray types: sprinkle hole 44, bell-bottomed hole 45, round hole 46 and flat hole 47.

Referring to DRAWING 7, it is another kind of application example of the outer corner and height adjustment of the spray head. The spray head 8 is connected to the water supply channel through a section of soft tube 48 covered with sleeve 49 which can be bent and positioned so as to constitute the universal adjustment structure of the outer corner and height of the spray head.

1. It is a small-size automatic water spray device. The characteristic is: it comprises hose, timer, control circuit, electromagnetic valve and spray head. The hose inlet is connected to the tap water and its outlet is connected to the spray head so as to form into the water supply channel where the electromagnetic valve is installed. The output signal of the timer is connected to the input port of the control circuit and the output port of the control circuit is connected to the control end of the electromagnetic valve.

2. As described in claims 1, the characteristic of the small-size automatic water spray device is that the said water supply channel is composed of the connections between the general route and two branch routes at least. The spray head is installed at the end of each branch route and the electromagnetic valve is installed on the general route or on each branch route.

3. As described in claims 1, the characteristic of the small-size automatic water spray device is that the said water supply channel forms into the tree-branch-shape channel by the connections of the general route, first-class branch route and second-class branch route. The spray head is installed at the end of the second-class branch route. The electromagnetic valve is installed on general route or on first-class branch route or on second-class branch route.

4. As described in claims 1, the characteristic of the small-size automatic water spray device is that the adjustment panel of water spray type is installed on the spray nozzle of said spray head. The spray holes of different water spray types are distributed at a distance around the circumference of the adjustment panel. The spray nozzle corresponds to the position of spray holes circumference. The spray nozzle, when turning the adjustment panel, corresponds respectively to the spray holes of different water spray types.

5. As described in claims 4, the characteristic of the family used small-size automatic water spray device is that the shape of the spray holes includes sprinkle hole, bell-bottomed hole, round hole and flat hole.

6. As described in claims 1, the characteristic of the small-size automatic water spray device is that the said spray head is connected to the water supply channel through a section of soft tube covered with sleeve which can be bent and positioned so as to constitute the universal adjustment structure of the outer corner and height of the spray head.

7. As described in claims 1, the characteristic of the small-size automatic water spray device is that the supporting stand is installed at the place of said spray head. The supporting stand comprises base stand, supporting pole and spray head pole. The supporting pole is inserted into the base stand and has a device to adjust the height and the spray head pole is installed on the supporting pole and the spray head can be turned and positioned on the spray head pole so as to constitute the adjustment structure of the outer corner and the height of the spray head.

8. As described in claims 1, the characteristic of the small-size automatic water spray device is that said timer, control circuit and electromagnetic valve are all disposed in a box on which there is a distribution channel in which the valve of electromagnetic valve is installed.
